(19) United States
(12) Patent Application Publication
(10) Pub. No.: US 2012/0038862 A1
(43) Pub. Date: Feb. 16, 2012

(54) LIQUID CRYSTAL DISPLAY PANEL AND COLOR FILTER SUBSTRATE

(75) Inventors: Yi-Hau Shiau, Taichung County (TW); Hsin-An Cheng, Hsinchu County (TW); Norio Sugiura, Hsinchu (TW); Pei-Chuan Yeh, Miaoli County (TW); Wang-Shou Kao, Hsinchu City (TW)

(73) Assignee: AU OPTRONICS CORPORATION, Hsinchu (TW)

(21) Appl. No.: 12/904,167

(22) Filed: Oct. 14, 2010

(30) Foreign Application Priority Data
Aug. 10, 2010 (TW) 99126609

(51) Int. Cl. G02F 1/1335; G02B 5/20

(52) U.S. Cl. 349/106; 349/194

(57) ABSTRACT

A liquid crystal display panel and a color filter substrate are provided. The color filter substrate includes a substrate, a stacked layer, a phase compensation film and a second alignment film. The stacked layer is disposed on the substrate and includes a first alignment film and a color filter layer having a phase compensation effect, wherein the first alignment film and the first alignment film are stacked on each other. The phase compensation film is disposed on the stacked layer. The second alignment film is disposed on the phase compensation film. Therefore, a number of fabrication processes of the color filter substrate can be reduced.

### CROSS-REFERENCE TO RELATED APPLICATION

This application claims the priority benefit of Taiwan application serial no. 99126609, filed on Aug. 10, 2010. The entirety of the above-mentioned patent application is hereby incorporated by reference herein and made a part of this specification.

### BACKGROUND

1. Field of the Invention

The invention relates to a liquid crystal display panel. Particularly, the invention relates to a color filter substrate of a liquid crystal display panel.

2. Description of Related Art

As liquid crystal displays (LCDs) are continually developed towards a large size display specification, to overcome a viewing angle problem of large size display, a wide viewing angle technology of LCD panels has to be continually developed. A multi-domain vertical alignment (MVA) LCD panel applies a commonly used wide viewing angle technology.

Generally, to improve optical performance of the MVA LCD panel, a horizontal phase compensation film (referred to as an A-plate phase compensation film) and a vertical phase compensation film (referred to as a C-plate phase compensation film) are disposed on a color filter substrate of the MVA LCD panel, i.e. at least a color filter film, the A-plate phase compensation film and the C-plate phase compensation film are disposed on the color filter substrate. Generally, alignment films are respectively disposed between the color filter film, the A-plate phase compensation film and the C-plate phase compensation film. Accordingly, in the conventional MVA LCD panel, layers of thin films on the color filter substrate thereof is relatively more, so that a thickness of the color filter substrate is relatively great. Moreover, since the color filter substrate has relatively more layers of the thin films, a number of fabrication processes thereof is relatively more, which may increase a fabrication cost of the color filter substrate.

### SUMMARY OF THE INVENTION

The invention is directed to a liquid crystal display panel and a color filter substrate thereof, which may have a relatively low fabrication cost.

The invention provides a color filter substrate including a substrate, a stacked layer, a phase compensation film and a second alignment film. The stacked layer is disposed on the substrate and includes a first alignment film and a color filter layer having a phase compensation effect, wherein the first alignment film and the color filter layer are stacked on each other. The phase compensation film is disposed on the stacked layer. The second alignment film is disposed on the phase compensation film.

In an embodiment of the invention, the first alignment film is disposed between the substrate and the color filter layer having the phase compensation effect.

In an embodiment of the invention, a phase retardation of the color filter layer having the phase compensation effect is substantially equivalent to a phase retardation of an A-plate compensation film, and the phase compensation film is a C-plate compensation film.

In an embodiment of the invention, a material of the C-plate phase compensation film includes polymer liquid crystal.

In an embodiment of the invention, a phase retardation of the color filter layer having the phase compensation effect is substantially equivalent to a phase retardation of a C-plate compensation film, and the phase compensation film is an A-plate compensation film.

In an embodiment of the invention, the color filter substrate further includes a third alignment film disposed between the phase compensation film and the color filter layer having the phase compensation effect.

In an embodiment of the invention, a material of the A-plate phase compensation film includes polymer liquid crystal.

In an embodiment of the invention, a material of the color filter layer having the phase compensation effect includes a pigment, a phase compensation material and a solvent. A weight percentage of the pigment is substantially greater than or equal to 30% and smaller than or equal to 54%. A weight percentage of the phase compensation material is substantially greater than or equal to 5% and smaller than or equal to 20%. A weight percentage of the solvent is substantially greater than or equal to 35% and smaller than or equal to 50%.

In an embodiment of the invention, a weight percentage of the pigment is substantially greater than or equal to 38% and smaller than or equal to 45%. Moreover, the pigment includes at least one of C.I. pigment red 122, C.I. pigment red 177, C.I. pigment red 202, C.I. pigment red 206, C.I. pigment red 209, C.I. pigment red 254, C.I. pigment red 255, C.I. pigment green 7, C.I. pigment green 36, C.I. pigment yellow 13, C.I. pigment yellow 55, C.I. pigment yellow 119, C.I. pigment yellow 138, C.I. pigment yellow 139, C.I. pigment yellow 150, C.I. pigment yellow 168, C.I. pigment violet 23, C.I. pigment orange 71, C.I. pigment blue 15:3, C.I. pigment blue 15:4, C.I. pigment blue 15:6, C.I. pigment black 1, C.I. pigment black 7, titanium oxide, barium sulphate, calcium carbonate, zinc oxide, titanium nitride, lead sulphate, yellow lead, zinc yellow, red iron oxide III, cadmium red, ultramarine blue, Prussian blue, chromium oxide green, cobalt green, amber, titanium black, synthetic iron black, and carbon back, or combinations thereof.

In an embodiment of the invention, a weight percentage of the phase compensation material is substantially equal to 10%. Moreover, the phase compensation material includes polymerizable liquid crystal molecules.

In an embodiment of the invention, a weight percentage of the solvent is substantially greater than or equal to 41% and smaller than or equal to 50%. Moreover, the solvent includes at least one of N-methylpyrrolidinone, ethylene glycol monobutyl ether, propylene glycol monomethyl ether, and propylene glycol monomethyl ether acetate, or combinations thereof.

In an embodiment of the invention, a weight percentage of the N-methyl pyrrolidinone is substantially equal to 1%, a weight percentage of the ethylene glycol monobutyl ether is substantially equal to 3.5%, a weight percentage of the propylene glycol monomethyl ether is substantially equal to 32.5%, and a weight percentage of the propylene glycol monomethyl ether acetate is substantially equal to 10%.

In an embodiment of the invention, the color filter layer having the phase compensation effect further includes an initiator, wherein a weight percentage of the initiator is substantially greater than 0% and smaller than or equal to 1%.

In an embodiment of the invention, a weight percentage of the initiator is substantially equal to 0.5%. Moreover, the initiator includes at least one of 1-hydroxycyclohexyl phenyl ketone, and 2-methyl-1-[4-(methylthio)phenyl]-2-morpholinopropane-1-one, or a combination thereof.

In an embodiment of the invention, the color filter layer having the phase compensation effect further includes a dispersant, wherein a weight percentage of the dispersant is substantially greater than 0% and smaller than or equal to 5%.

In an embodiment of the invention, a weight percentage of the dispersant is substantially greater than or equal to 1% and smaller than or equal to 3.5%. Moreover, the dispersant includes a polymer dispersant.

In an embodiment of the invention, the color filter substrate further includes a common electrode disposed between the phase compensation film and the second alignment film.

In an embodiment of the invention, the color filter substrate further includes an overcoat disposed between the common electrode and the phase compensation film.

In an embodiment of the invention, the color filter substrate further includes a plurality of spacers disposed between the common electrode and the second alignment film.

In an embodiment of the invention, the color filter substrate further includes a plurality of alignment protrusions disposed between the common electrode and the second alignment film.

The invention provides a liquid crystal display (LCD) panel including an active device array substrate, a color filter substrate, a liquid crystal layer and a third alignment film. The color filter substrate is disposed above the active device array substrate, and includes a substrate, a stacked layer, a phase compensation film and a second alignment film. The stacked layer is disposed on the substrate and includes a first alignment film and a color filter layer having a phase compensation effect, wherein the first alignment film and the color filter layer are stacked on each other. The phase compensation film is disposed on the stacked layer. The second alignment film is disposed on the phase compensation film. The liquid crystal layer is disposed between the active device array substrate and the second alignment film. The third alignment film is disposed between the active device array substrate and the liquid crystal layer.

According to the above descriptions, in the LCD panel and the color filter substrate of the invention, the color filter layer having the phase compensation effect is used to replace the A-plate phase compensation film or the C-plate phase compensation film. In this way, a number of layers of the color filter substrate can be reduced, so as to simplify fabrication processes and reduce a fabrication cost of the color filter substrate.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A-1G are schematic diagrams illustrating a fabrication process of a color filter substrate according to an embodiment of the invention.

FIG. 2 is a side view of a liquid crystal display panel according to an embodiment of the invention.

FIG. 3 is a side view of a color filter substrate according to another embodiment of the invention.

### DETAILED DESCRIPTION OF DISCLOSED EMBODIMENTS

### First Embodiment

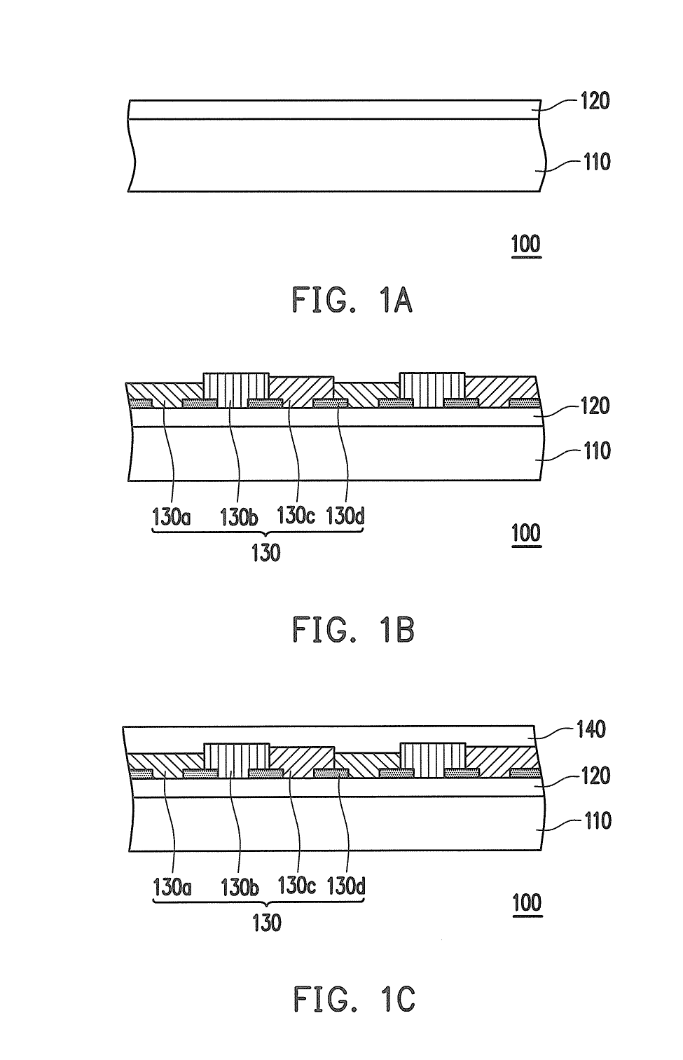

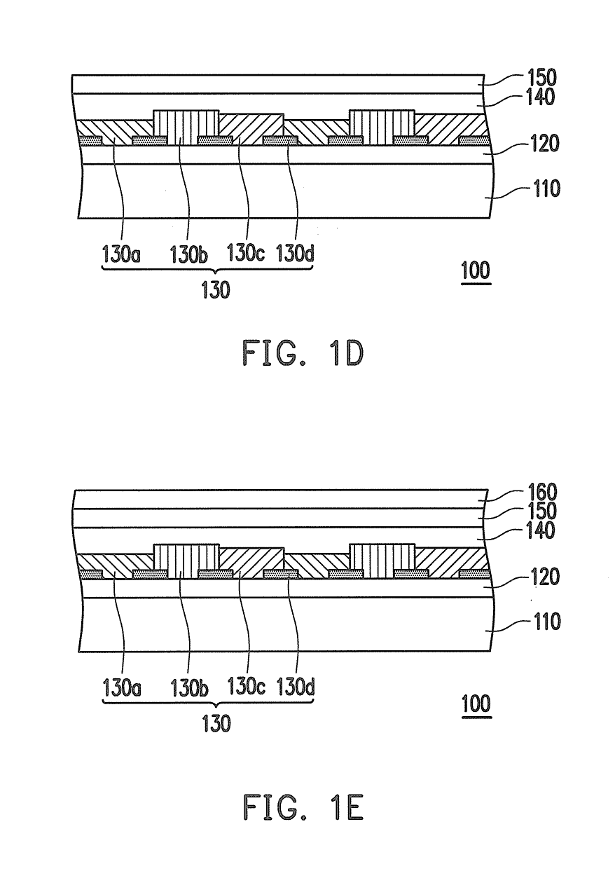

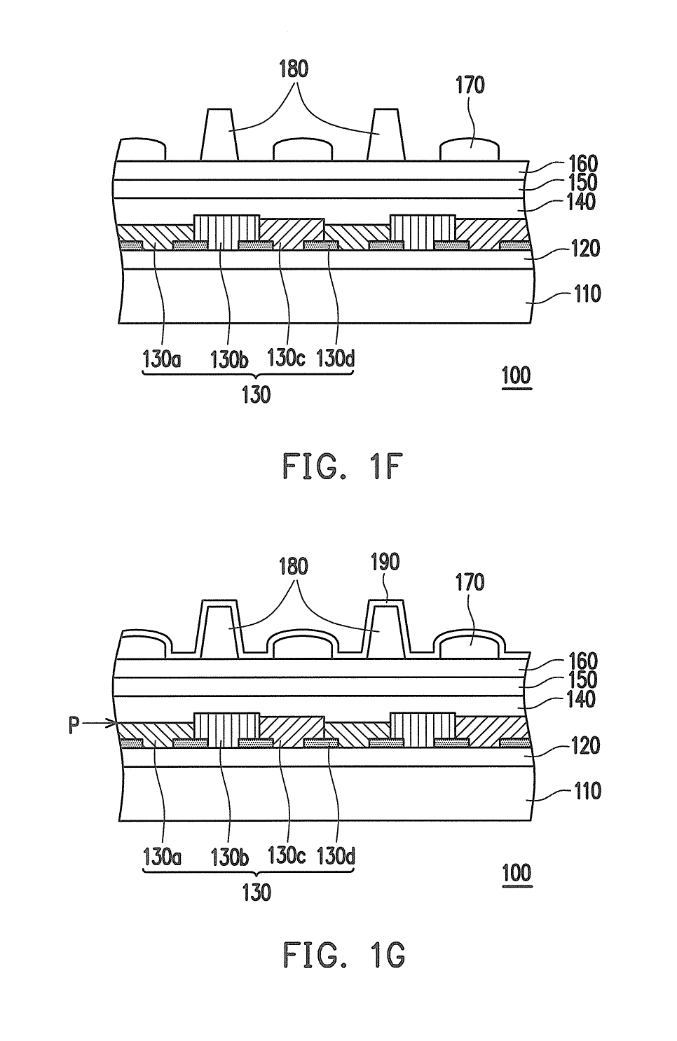

FIGS. 1A-1G are schematic diagrams illustrating a fabrication process of a color filter substrate according to an embodiment of the invention. Referring to FIG. 1A, an alignment film 120 is formed on a substrate 110, wherein a material of the alignment film 120 is, for example, polyimide or polymethyl methacrylate. Then, a color filter layer 130 is formed on the alignment film 120, as that shown in FIG. 1B. The color filter layer 130 has a phase compensation effect, and in the present embodiment, a phase retardation of the color filter layer 130 is substantially equivalent to a phase retardation of an A-plate phase compensation film. In other words, the color filter layer 130 has both of the phase retardation function and the color filter function.

In detail, a process of forming the color filter layer 130 is as follows. A plurality of black matrices 130d is formed on the alignment film 120. Then, a red filter film 130a, a green filter film 130b and a blue filter film 130c are disposed between the black matrices 130d, and the red filter film 130a, the green filter film 130b and the blue filter film 130c have a phase retardation substantially equivalent to that of the A-plate phase compensation film. Moreover, thickness of the red filter film 130a, the green filter film 130b and the blue filter film 130c can be the same or different.

Then, a phase compensation film 140 is formed on the color filter layer 130, as that shown in FIG. 1C. In the present embodiment, the phase compensation film 140 is, for example, a C-plate phase compensation film, and a material thereof is, for example, solid state/liquid state polymer liquid crystal. Preferably, the material of C-plate phase compensation film is, for example, solid state polymer liquid crystal. Then, an overcoat 150 is formed on the phase compensation film 140, as that shown in FIG. 1D. In the present embodiment, a material of the overcoat 150 is, for example, SiNx, SiOy or SiOxNy. Then, a common electrode 160 is formed on the overcoat 150, as that shown in FIG. 1E. A material of the common electrode 160 is, for example, a transparent conductive oxide such as indium tin oxide (ITO) or indium zinc oxide (IZO).

Then, a plurality of alignment protrusions 170 and a plurality of spacers 180 are formed on the common electrode 160, as that shown in FIG. 1F. After the alignment protrusions 170 and the spacers 180 are fabricated, an alignment film 190 is formed on the common electrode 160, the alignment protrusions 170 and the spacers 180, as that shown in FIG. 1G. After the alignment film 190 is fabricated, fabrication of the color filter substrate 100 of the present embodiment is roughly completed. It should be noticed that the overcoat 150, the common electrode 160, the alignment protrusions 170 and the spacers 180 can be optional components.

Referring to FIG. 1G, in the present embodiment, the color filter substrate 100 includes the substrate 110, the alignment films 120 and 190, the color filter layer 130, the phase compensation film 140, the overcoat 150, the common electrode 160, the alignment protrusions 170 and the spacers 180. The alignment film 120 is disposed on the substrate 110, the color filter layer 130 is disposed on the alignment film 120, the phase compensation film 140 is disposed on the color filter layer 130, the overcoat 150 is disposed on the phase compensation film 140, the common electrode 160 is disposed on the overcoat 150, the alignment protrusions 170 and the spacers 180 are disposed on the common electrode 160, and the alignment film 190 is disposed on the common electrode 160, the alignment protrusions 170 and the spacers 180.

Further, the alignment film 120 and the color filter layer 130 can be regarded as a stacked layer, and in the present embodiment, the color filter layer 130 is stacked on the alignment film 120, though in other embodiments, the alignment film 120 can also be stacked on the color filter layer 130, i.e. positions and a forming sequence of the alignment film 120 and the color filter layer 130 can be exchanged. Moreover, in other applicable embodiments, an alignment film can be further disposed between the color filter layer 130 and the phase compensation film 140 (for example, a position pointed by an arrow P).

According to the above descriptions, since the color filter layer 130 has the phase compensation effect, and the phase retardation of the color filter layer 130 is substantially equivalent to that of the A-plate phase compensation film, the color filter layer 130 can be used to replace the A-plate phase compensation film. In this way, under a premise of maintaining an original optical performance of the color filter substrate 100, a number of layers of the color filter substrate 100 can be reduced, so that fabrication processes and a fabrication cost of the color filter substrate 100 can be reduced.

Moreover, in the present embodiment, the color filter layer 130 includes the aforementioned red filter film 130a, the green filter film 130b, the blue filter film 130c and the black matrices 130d, though in other embodiments, the color filter layer 130 may also include color filter films of other colors. It should be noticed that the color filter layer 130 having the phase compensation effect is formed through a suitable reaction (for example, a thermal or an optical process) of a solution having special ingredients.

The solution used for fabricating the color filter layer 130 includes a pigment, a phase compensation material and a solvent. In other exemplary embodiments, the solution further includes an initiator and/or a dispersant. The dispersant helps evenly distributing the pigment or other components (for example, the phase compensation material and the initiator, etc.) in the solvent. If the phase compensation material has a polymerizable functional group, the initiator may help accelerating a polymerisation reaction of the polymerizable functional group. Certainly, if the phase compensation material does not have the polymerizable functional group, the initiator is not required.

The pigment is mainly used for providing a color filtering effect, i.e. forming a color of the color filter film. Compared to a weight of the whole solution, a weight percentage of the pigment is substantially greater than or equal to 30% and smaller than or equal to 54%, and preferably greater than or equal to 38% and smaller than or equal to 45%. The pigment can be various organic pigments or inorganic pigments having colors. The organic pigments are, for example, C.I. pigment red 122, C.I. pigment red 177, C.I. pigment red 202, C.I. pigment red 206, C.I. pigment red 209, C.I. pigment red 254, C.I. pigment red 255, C.I. pigment green 7, C.I. pigment green 36, C.I. pigment yellow 13, C.I. pigment yellow 55, C.I. pigment yellow 119, C.I. pigment yellow 138, C.I. pigment yellow 139, C.I. pigment yellow 150, C.I. pigment yellow 168, C.I. pigment violet 23, C.I. pigment orange 71, C.I. pigment blue 15:3, C.I. pigment blue 15:4, C.I. pigment blue 15:6, C.I. pigment black 1, C.I. pigment black 7, etc., though the invention is not limited thereto. The inorganic pigments, are for example, titanium oxide, barium sulphate, calcium carbonate, zinc oxide, titanium nitride, lead sulphate, yellow lead, zinc yellow, red iron oxide III, cadmium red, ultramarine blue, Prussian blue, chromium oxide green, cobalt green, amber, titanium black, synthetic iron black, and carbon back, etc., though the invention is not limited thereto. One of the above various pigment components can be selected for utilization, or various pigment components can be arbitrarily combined for utilization, so as to provide the required color filtering effect. It should be noticed that the pigment referred in the present embodiment is differentiated from a dye. A general dye can be dissolved in a solvent, which may influence a phase compensation effect of the phase compensation material. Moreover, the dye has a poor optical stability and is easy to produce a photodecomposition phenomenon. The pigment used in the present embodiment is not dissolved in the solvent used in the present embodiment, but is evenly spread in the solvent in form of particles, so that a better optical stability is provided, and the phase compensation effect is not influenced.

The phase compensation material is used for providing a phase compensation function. Compared to the weight of the whole solution, a weight percentage of the phase compensation material is substantially greater than or equal to 5% and smaller than or equal to 20%, and preferably equal to 10%. The phase compensation material is generally a polymerizable liquid crystal (PLC) material, which has a main part and a polymerizable functional group part. For example, a monomer structure of the PLC material can be as follows:

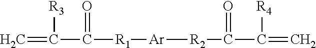

wherein R₁ and R₂ are dissimilar, and are chain segments containing heteroatoms, so that reactivity of an ethylene double bond having R₃ is higher than that of an ethylene double bond having R₄. R₁ and R₂ respectively contain a following structure:

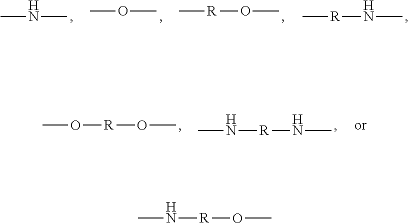

etc.

wherein R is an alkyl of C₁-C₁₂. R₃ and R₄ are respectively independent, and are respectively selected from H or CH₃. Ar is an aromatic ring, which can be a Phenyl, naphthyl, anthryl, or heterocyclic aromatic ring. Taiwan Patent No. 1323278 can be referred for a detailed implementation of the polymerizable liquid crystal molecules of the present embodiment, and in other embodiments, the phase compensation material can be other non-liquid crystal materials, though the phase compensation function can still be achieved.

If the phase compensation material has the polymerizable functional group, the initiator can be added to accelerate the polymerisation reaction of the polymerizable functional group. The initiator can be various optical initiators or thermal initiators. Compared to the weight of the whole solution, a weight percentage of the initiator is substantially greater than 0% and smaller than or equal to 1%, and preferably equal to 0.5%. The initiator is, for example, 1-hydroxycyclohexyl phenyl ketone, or 2-methyl-1-[4-(methylthio)phenyl]-2-morpholinopropane-1-one, though the invention is not limited thereto.

The dispersant helps evenly distributing the phase compensation material or other components (for example, the pigment and the initiator, etc.) in the solution. Compared to the weight of the whole solution, a weight percentage of the dispersant is substantially greater than 0% and smaller than or equal to 5%, and preferably greater than or equal to 1% and smaller than or equal to 3.5%. The dispersant can be an anionic dispersant, a cationic dispersant, a non-ionic surfactant or a polymer dispersant, and is preferably the polymer dispersant.

A weight percentage of the solvent is substantially greater than or equal to 35% and smaller than or equal to 50%, and preferably greater than or equal to 41% and smaller than or equal to 50%. The solvent of the present embodiment includes alcohols, ketones, ethers, esters or combinations thereof. The alcohol solvent is, for example, N-butanol, 2-butanol, tertiary butyl alcohol, or isopropyl alcohol. The ketone solvent is, for example, N-methylpyrrole ketone, cyclohexanone, methyl ethyl ketone, or methyl tertiary butyl ketone. The ether solvent is, for example, glycol ethers, glycol ether, ethylene glycol monobutyl ether, or propylene glycol monomethyl ether. The ester solvent is, for example, propylene glycol monomethyl ether acetate, propylene glycol monomethyl ether acetate, ethyl-2-ethoxyethanol acetate, 3-ethoxy ethyl propionate, or isoamyl acetate, though the invention is not limited thereto. In an exemplary embodiment, the solvent is formed by mixing N-methylpyrrole ketone, ethylene glycol monobutyl ether, propylene glycol monomethyl ether, and propylene glycol monomethyl ether acetate according to a certain proportion. For example, compared to the weight of the whole solution, a weight percentage of the N-methyl pyrrole ketone is substantially equal to 1%, a weight percentage of the ethylene glycol monobutyl ether is substantially equal to 3.5%, a weight percentage of the propylene glycol monomethyl ether is substantially equal to 32.5%, and a weight percentage of the propylene glycol monomethyl ether acetate is substantially equal to 10%.

Moreover, other additives can be added to the solution used for fabricating the color filter layer 130 according to an actual design requirement, for example, catalysts, sensitizers, stabilizers, chain transfer agents, inhibitors, common reactive monomers, interface active compounds, lubricants, wetting agents, hydrophobic agents, adhesives, flow improving agents, defoamers, degassing agents, diluents, reactive diluents, auxiliary agents, and coloring agents, etc., though the invention is not limited thereto. It should be noticed that the above solution components can also be evenly distributed in the solvent with assistant of the dispersant.

### Second Embodiment

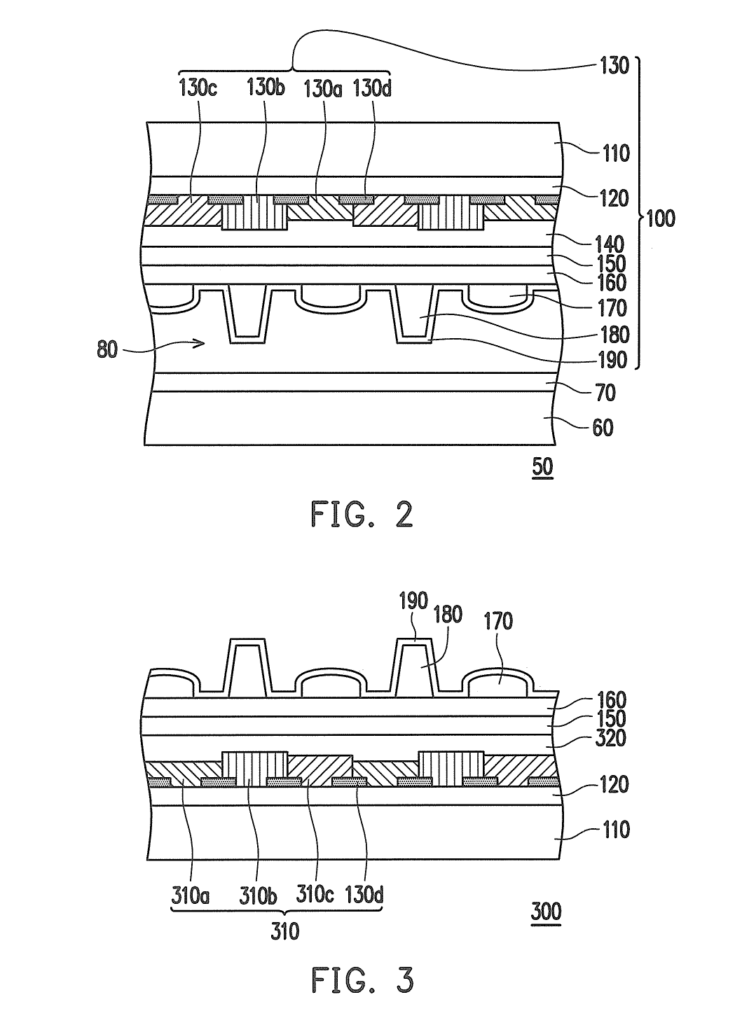

FIG. 2 is a side view of an LCD panel according to an embodiment of the invention. Referring to FIG. 2, after fabrication of the color filter substrate 100 is completed, the color filter substrate 100 and an active device array substrate 60 can be assembled to form an LCD panel 50, and liquid crystal is filled between the color filter substrate 100 and the active device array substrate 60 to form a liquid crystal layer 80. In the present embodiment, an alignment film 70 can be formed on the active device array substrate 60. According to the above descriptions, the LCD panel 50 of the present embodiment includes the active device array substrate 60, the alignment film 70, the liquid crystal layer 80 and the color filter substrate 100, wherein the color filter substrate 100 is as that described with reference of FIGS. 1A-1G, so that a detailed description thereof is not repeated. In the present embodiment, the alignment film 70 is disposed on the active device array substrate 60, the liquid crystal layer 80 is disposed on the alignment film 70, and the color filter substrate 100 is disposed on the liquid crystal layer 80.

When a driving voltage is applied between the assembled active device array substrate 60 and the color filter substrate 100, if the alignment protrusions 170 are optionally disposed, the liquid crystal molecules in the liquid crystal layer 80 can lean towards different directions to form a plurality of domains, so as to achieve a wide viewing angle display effect, though the invention is not limited thereto, and according to an actual design requirement, the invention can also be applied to a transmissive display panel, a trans-reflective display panel, a reflective display panel, a double-sided display panel, a vertical alignment (VA) display panel, an in plane switch (IPS) display panel, a multi-domain vertical alignment (MVA) display panel, a twist nematic (TN) display panel, a super twist nematic (STN) display panel, a patterned-silt vertical alignment (PVA) display panel, a super patterned-silt vertical alignment (S-PVA) display panel, an advance super view (ASV) display panel, a fringe field switching (FFS) display panel, a continuous pinwheel alignment (CPA) display panel, an axially symmetric aligned micro-cell mode (ASM) display panel, an optical compensation banded (OCB) display panel, a super in plane switching (S-IPS) display panel, an advanced super in plane switching (AS-IPS) display panel, an ultra-fringe field switching (UFFS) display panel, a polymer stabilized alignment (PSA) display panel, a dual-view display panel, a triple-view display panels, or other types of display panels or combinations thereof, or an organic light-emitting device according to a material (for example, a liquid crystal layer, an organic light-emitting layer (for example, small molecules, polymer, or a combination thereof), a blue phase material, a ferro-electric material, or combinations thereof) electrically contacting at least one of a pixel electrode and a drain electrode thereof.

### Third Embodiment

FIG. 3 is a side view of a color filter substrate according to another embodiment of the invention. Referring to FIG. 1G and FIG. 3, a structure of the color filter substrate 300 is similar to that of the color filter substrate 100, and a difference there between lies in a color filter layer 310 and a phase compensation film 320, wherein the same reference numerals refer to the same components. In the present embodiment, a phase retardation of the color filter layer 310 is substantially equivalent to the phase retardation of the C-plate phase compensation film, i.e. phase retardations of a red filter film 310a, a green filter film 310b and a blue filter film 310c are all substantially equivalent to the phase retardation of the C-plate phase compensation film. Moreover, the phase compensation film 320 is, for example, the A-plate phase compensation film, and a material thereof is, for example, polymer liquid crystal. Preferably, the material of A-plate phase compensation film is, for example, solid state polymer liquid crystal. Therefore, under a premise of maintaining the optical performance of the color filter substrate 100, the number of layers of the color filter substrate 100 can also be reduced, so that fabrication processes and a fabrication cost of the color filter substrate 100 can be reduced.

In summary, in the LCD panel and the color filter substrate of the invention, the color filter layer having the phase compensation effect is used to replace the A-plate phase compensation film or the C-plate phase compensation film. In this way, the number of layers of the color filter substrate can be reduced, so as to simplify the fabrication processes and reduce a fabrication cost of the color filter substrate.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A color filter substrate, comprising:
a substrate;
a stacked layer disposed on the substrate and comprising a first alignment film and a color filter layer having a phase compensation effect, wherein the first alignment film and the color filter layer are stacked on each other;
a phase compensation film disposed on the stacked layer; and
a second alignment film disposed on the phase compensation film.

2. The color filter substrate as claimed in claim 1, wherein the first alignment film is disposed between the substrate and the color filter layer having the phase compensation effect.

3. The color filter substrate as claimed in claim 1, wherein a phase retardation of the color filter layer having the phase compensation effect is substantially equivalent to a phase retardation of an A-plate compensation film, and the phase compensation film is a C-plate compensation film.

4. The color filter substrate as claimed in claim 3, further comprising a third alignment film disposed between the phase compensation film and the color filter layer having the phase compensation effect.

5. The color filter substrate as claimed in claim 3, wherein a material of the C-plate phase compensation film comprises polymer liquid crystal.

6. The color filter substrate as claimed in claim 1, wherein a phase retardation of the color filter layer having the phase compensation effect is substantially equivalent to a phase retardation of a C-plate compensation film, and the phase compensation film is an A-plate compensation film.

7. The color filter substrate as claimed in claim 6, further comprising a third alignment film disposed between the phase compensation film and the color filter layer having the phase compensation effect.

8. The color filter substrate as claimed in claim 1, wherein a material of the A-plate phase compensation film comprises polymer liquid crystal.

9. The color filter substrate as claimed in claim 1, wherein a material of the color filter layer having the phase compensation effect comprises:
a pigment, wherein a weight percentage of the pigment is substantially greater than or equal to 30% and smaller than or equal to 54%;
a phase compensation material, wherein a weight percentage of the phase compensation material is substantially greater than or equal to 5% and smaller than or equal to 20%; and
a solvent, wherein a weight percentage of the solvent is substantially greater than or equal to 35% and smaller than or equal to 50%.

10. The color filter substrate as claimed in claim 9, wherein a weight percentage of the pigment is substantially greater than or equal to 38% and smaller than or equal to 45%.

11. The color filter substrate as claimed in claim 9, wherein the pigment comprises at least one of C.I. pigment red 122, C.I. pigment red 177, C.I. pigment red 202, C.I. pigment red 206, C.I. pigment red 209, C.I. pigment red 254, C.I. pigment red 255, C.I. pigment green 7, C.I. pigment green 36, C.I. pigment yellow 13, C.I. pigment yellow 55, C.I. pigment yellow 119, C.I. pigment yellow 138, C.I. pigment yellow 139, C.I. pigment yellow 150, C.I. pigment yellow 168, C.I. pigment violet 23, C.I. pigment orange 71, C.I. pigment blue 15:3, C.I. pigment blue 15:4, C.I. pigment blue 15:6, C.I. pigment black 1, C.I. pigment black 7, titanium oxide, barium sulphate, calcium carbonate, zinc oxide, titanium nitride, lead sulphate, yellow lead, zinc yellow, red iron oxide III, cadmium red, ultramarine blue, Prussian blue, chromium oxide green, cobalt green, amber, titanium black, synthetic iron black, and carbon back, or combinations thereof.

12. The color filter substrate as claimed in claim 9, wherein a weight percentage of the phase compensation material is substantially equal to 10%.

13. The color filter substrate as claimed in claim 9, wherein the phase compensation material comprises polymerizable liquid crystal molecules.

14. The color filter substrate as claimed in claim 9, wherein a weight percentage of the solvent is substantially greater than or equal to 41% and smaller than or equal to 50%.

15. The color filter substrate as claimed in claim 9, wherein the solvent comprises at least one of N-methylpyrrolidinone, ethylene glycol monobutyl ether, propylene glycol monomethyl ether, and propylene glycol monomethyl ether acetate, or combinations thereof.

16. The color filter substrate as claimed in claim 15, wherein a weight percentage of the N-methylpyrrolidinone is substantially equal to 1%, a weight percentage of the ethylene glycol monobutyl ether is substantially equal to 3.5%, a weight percentage of the propylene glycol monomethyl ether is substantially equal to 32.5%, and a weight percentage of the propylene glycol monomethyl ether acetate is substantially equal to 10%.

17. The color filter substrate as claimed in claim 9, wherein the color filter layer having the phase compensation effect further comprises an initiator, wherein a weight percentage of the initiator is substantially greater than 0% and smaller than or equal to 1%.

18. The color filter substrate as claimed in claim 9, wherein a weight percentage of the initiator is substantially equal to 0.5%.

19. The color filter substrate as claimed in claim 9, wherein the initiator comprises at least one of 1-hydroxycyclohexyl phenyl ketone, and 2-methyl-1-[4-(methylthio)phenyl]-2-morpholinopropane-1-one, or a combination thereof.

20. The color filter substrate as claimed in claim 9, wherein the color filter layer having the phase compensation effect further comprises a dispersant, wherein a weight percentage of the dispersant is substantially greater than 0% and smaller than or equal to 5%.

21. The color filter substrate as claimed in claim 20, wherein a weight percentage of the dispersant is substantially greater than or equal to 1% and smaller than or equal to 3.5%.

22. The color filter substrate as claimed in claim 20, wherein the dispersant includes a polymer dispersant.

23. The color filter substrate as claimed in claim 1, further comprising a common electrode disposed between the phase compensation film and the second alignment film.

24. The color filter substrate as claimed in claim 23, further comprising an overcoat disposed between the common electrode and the phase compensation film.

25. The color filter substrate as claimed in claim 23, further comprising a plurality of spacers disposed between the common electrode and the second alignment film.

26. The color filter substrate as claimed in claim 23, further comprising a plurality of alignment protrusions disposed between the common electrode and the second alignment film.

27. A liquid crystal display panel, comprising:
an active device array substrate;
a color filter substrate disposed above the active device array substrate, and comprising:
a substrate;
a stacked layer disposed on the substrate and comprising a first alignment film and a color filter layer having a phase compensation effect, wherein the first alignment film and the color filter layer are stacked on each other;
a phase compensation film disposed on the stacked layer;
a second alignment film disposed on the phase compensation film;
a liquid crystal layer disposed between the active device array substrate and the second alignment film; and
a third alignment film disposed between the active device array substrate and the liquid crystal layer.
